(19) United States
(12) Patent Application Publication
(10) Pub. No.: US 2024/0223416 A1
(43) Pub. Date: Jul. 4, 2024

(54) FREQUENCY OFFSET DETERMINATION FOR RADIO DEVICES

(71) Applicant: Intel Corporation, Santa Clara, CA (US)

(72) Inventors: Hossein ALAVI, Portland, OR (US); Elan BANIN, Raanana (IL); Ofir DEGANI, Nes-Ammin (IL); Ashoke RAVI, Portland, OR (US)

(21) Appl. No.: 18/147,736

(22) Filed: Dec. 29, 2022

(51) Int. Cl. H04L 27/00; H04L 27/26

(52) U.S. Cl. CPC H04L 27/0014; H04L 27/2657; H04L 2027/0016; H04L 2027/0026

(57) ABSTRACT

A system includes a processor configured to determine a frequency offset between a first local oscillator and a second local oscillator using a combined radio signal received at a first transceiver circuit; wherein the combined radio signal comprises a first signal transmitted by the first transceiver circuit and a second signal transmitted by a second transceiver circuit.

### TECHNICAL FIELD

Various aspects of this disclosure generally relate to the determination of frequency offset between local oscillators in radio communication.

### BACKGROUND

Conventional wireless communication systems (e.g., Wi-Fi, Bluetooth, etc.) include physically attached digital baseband (BB) and radio frequency (RF) blocks, connected to antenna(s) via RF cable interconnect(s). In these systems, the antenna is commonly placed close to the transceiver to reduce the length of the RF cable, which is advantageous by reducing bulk, cost, and energy inefficiency (e.g., loss).

Multiple-input, multiple-output (MIMO) and phased array techniques require interconnection to multiple antennas distributed across the platform, which lengthens the RF cable and thus increases bulk, cost, and energy inefficiency.

In the future, it is expected that distributed radio systems (DRS) will become increasingly common. A DRS architecture may include a centrally integrated connectivity (CNVi) module with a Wi-Fi Media Access Control (MAC) and Bluetooth controller plus a detached satellite radiofrequency (RF) radio-head (RH) transceiver dedicated and attached to each antenna (active antennas). The RH and antenna modules may be physically distributed across the platform. The DRS architecture, therefore, eliminates the high cost and loss of RF cables and replaces them with digital interconnects, at the cost of requiring a dedicated crystal local oscillator for RF up-conversion in each RH. MIMO or phased-array systems, however, require extremely fast and accurate synchronization of all RH local oscillators. Synchronization mechanisms generally require some measure of phase or frequency error signal as feedback to be minimized. Traditionally, extraction of this error signal requires an RF interconnect, which is preferably avoided in DRS.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts a MIMO device;

FIG. 2 depicts a multiple radiohead DRS configuration;

FIG. 3 depicts a signal cancellation to isolate the second transmit signal;

FIG. 4 depicts an adaptive filtering device for iteratively improving an estimation of a;

FIG. 5 depicts an orthogonal frequency division multiplexing symbol framework;

FIG. 6 depicts a determination of frequency offset based on received signals Rx1 and Tx1;

FIGS. 7 and 8 depict acquisition and tracking estimation error plots;

FIG. 9 depicts expected sigma variation increasing with a smaller integration window;

FIG. 10 a diminishing tracking error expected sigma variation;

FIG. 11 system for determining a phase offset;

FIG. 12 depicts a first method of frequency offset determination; and

FIG. 13 depicts a second method of frequency offset determination.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

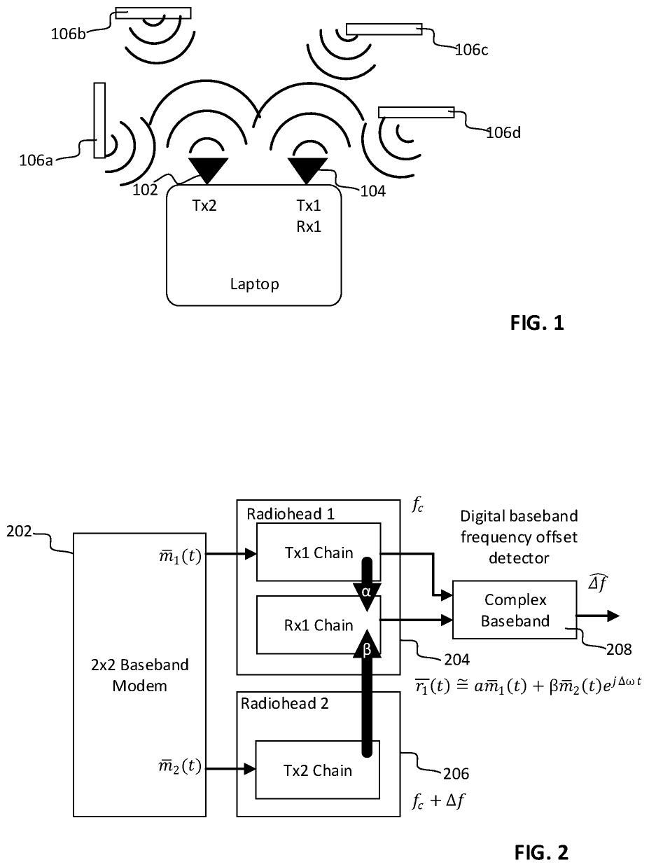

FIG. 1 depicts a MIMO device that is configured to simultaneously or concurrently transmit a first transmission chain (Tx1) on a first antenna and transmit a second transmission chain (Tx2) on a second antenna. The 2×2 MIMO configuration depicted herein is used for demonstrative purposes, and the principles and methods disclosed herein are not limited to a 2×2 configuration and may be expanded to incorporate other MIMO configurations. In this device, a feedback receiver in RH1 receives the aggregate transmission leakage from Tx1 and Tx2 (e.g. receives transmissions directly from the first antenna (e.g. for transmitting Tx1) and the second antenna (for transmitting Tx2), and/or attenuated reflections of the transmissions of Tx1 and Tx2, as reflected from any of one or more objects. This is indicated by the formula below:

$${Rx}_{1} = α {Tx}_{1} + β {e}^{j 2 π Δ ft} {Tx}_{2} \qquad ( 1 )$$

in which α and β are leakage path losses (e.g. attenuations) to RX1 and Δf is the frequency offset between RH1 and RH2. The frequency offset Δf may be estimated in two phases:

Initial acquisition: In a first phase, and using a training-field at the start of a packet (e.g. of Tx1 and Tx2), α, β and Δf are estimated from received samples of T×1, such that Rx₁=αp₁+βe^{j2πΔft}p₂ (where p₁ and p₂ are known). In some configurations, this can be achieved with an estimation time of less than 8 us (e.g., using legacy short training fields (L-STF)). The process of estimating α, β and Δf will be described in greater detail below.

Frequency drifts tracking: During each OFDM payload symbol transmission, the signal Tx₁ (which is known) may be subtracted from Rx₁=αTx₁+βe^{j2πΔft}Tx₂. The resulting signal includes a redundant portion (e.g. a Cyclic Prefix) that can be used to track a phase shift of Tx2 relative to Tx1. From the determined phase shift, the frequency offset may be isolated. Details of this procedure will be proceed below.

First, and by way of background, in a transmission operation (e.g., a Wireless Local Area Network (WLAN) operation, a Wireless Wide Area Network (WWAN) operation, etc.) of a device having a baseband modem with two transmit antenna ports 102 and 104 (e.g., 2×2 MIMO), the device transmits two distinct time and frequency synchronous OFDM signal streams through two separate antennas (depicted as Tx1 and Tx2). These signals radiate from the respective transmit antenna and are partially reflected back to the device, such as by surrounding obstacles, which are depicted as 106a-106d. This creates cross-radio-head multipath leakage channels.

In some circumstances, a single device as in FIG. 1 will have a single local oscillator for sending signals. However, as distributed radio networks become more commonly implemented, it has become increasingly common to transmit a MIMO signal using two devices (e.g., a system with two radio heads, a DRS system) with their own local oscillators. Since these local oscillators will inevitably exhibit a frequency offset and will tend to become unsynchronized. Since MIMO communication is relatively intolerant to poor synchronization, strategies must be developed to identify the frequency offset between the two local oscillators so that satisfactory synchronization can be achieved.

Turning to FIG. 2, this figure depicts a multiple radiohead DRS configuration. In this figure, a baseband modem 202 is connected to a first RH 204 and a second RH 206. The first RH 204 as depicted includes a first Tx chain (Tx1), and the second RH 206 includes a second Tx chain (Tx2). Maintaining tight synchronization of the two RHs is critical for MIMO operation. Synchronization of the local oscillators requires real-time knowledge of any offset frequency Δf between the transmitters (e.g. between the local oscillators).

Such synchronization may be achieved by compensating for the frequency offset between the local oscillators. This frequency offset may be obtained by analyzing a received signal Rx1, which includes attenuated reflections of Tx1 and Tx2, as will be described herein. Returning to FIG. 2, the first RH 204 and the second RH 206 are configured to simultaneously or concurrently transmit Tx1 and Tx2, respectively. During this transmission, the first RH 204 is also configured to receive Rx1. Rx1 includes reflections of each of Tx1 (these reflections are denoted by α) and Tx2 (these reflections are denoted by β). That is, one or more objects may reflect Tx1 and/or Tx2 back to the first RH 204. Of note, RH1 is able to simultaneously or concurrently transmit the Tx1 chain and receive the Rx1 chain.

The Rx1 receive chain includes a superposition of RH1 and RH2 transmission leakages (e.g., reflections of Tx1 and Tx2), which may be mathematically expressed as:

$${Rx}_{1} = α {Tx}_{1} + β {e}^{j 2 π Δ f} {Tx}_{2} \qquad ( 2 )$$

That is, RH1 receives a superposition of reflections of Tx1 transmission from RH1 and reflections of Tx2 transmission from RH2, with α and β path loss respectively and Δf offset frequency. The terms α and β are complex path loss coefficients from the two transmitters to RH1, and Δf is the offset frequency. The device may calculate the offset frequency using either or both of the operations: a first operation for frequency offset acquisition, which may be completed within the first preamble training period, and second or subsequent operation for ongoing frequency tracking.

### Frequency Offset Acquisition

The device may be configured to perform an initial frequency offset acquisition procedure, which may permit an initial assessment of frequency offset that will permit any further frequency offset to be dynamically compensated for in the subsequent tracking operation.

In the initial frequency offset operation, the device perpends each payload packet in Tx₁ and Tx₂ with a set of distinct a-priori known preamble symbols that are specific to each transmitter stream. The first preamble symbol, which is conventionally called LSTF (Legacy Short Training Field), is conventionally 8 μs long (although changes to the length in future protocols would not be expected to alter the feasibility of the frequency offset acquisition procedure as described herein) and conventionally includes 10 repetitions of a pseudo-noise subsequence with a duration of 0.8 μs. Proper functioning of MIMO operation requires an initial frequency synchronization of transmission streams after the 8 μs LSTF symbol. This may be achieved as follows:

Let p₁=LSTF₁ for Tx₁ and p₂=LSTF₂ for Tx₂, sample time=Tₛ and r[i]=iₜₕ received sample. Assuming time synchronized streams with N LSTF samples, then:

$$r [ i ] = α {p}_{1} [ i ] + β {e}^{j 2 π ( i - 1 ) Δ {fT}_{s}} {p}_{2} [ i ] ; \to α {p}_{1} [ i ] + β {e}^{i - 1} {p}_{2} [ i ] = r [ i ] ; \\ where i ∈ [ 1 , N ] and ε = {e}^{j ( 2 πΔ {fT}_{s} )} \qquad ( 3 )$$

Equation 3 describes of a system of N equations and 3 complex scaler unknowns α, β and ε, constrained to |ε|=1. Using the N equations, the device may solve for α, β and ε, provided that N≥3. Many conventional, numerical methods are available to solve this system of equations, and the skilled person will appreciate that any of these numerical methods may be used. Once α, β and ε are solved for, the device may determine (e.g., calculate, estimate, etc.) the frequency offset from the complex phase of E and therefore synchronize the transmissions of RH1 and RH2. Specifically, the frequency offset can be derived from the determined phase of Tx2 using the following formula:

$$Δ {f}_{aquisition} = \frac{phase ( ε )}{2 π {T}_{s}} \qquad ( 4 )$$

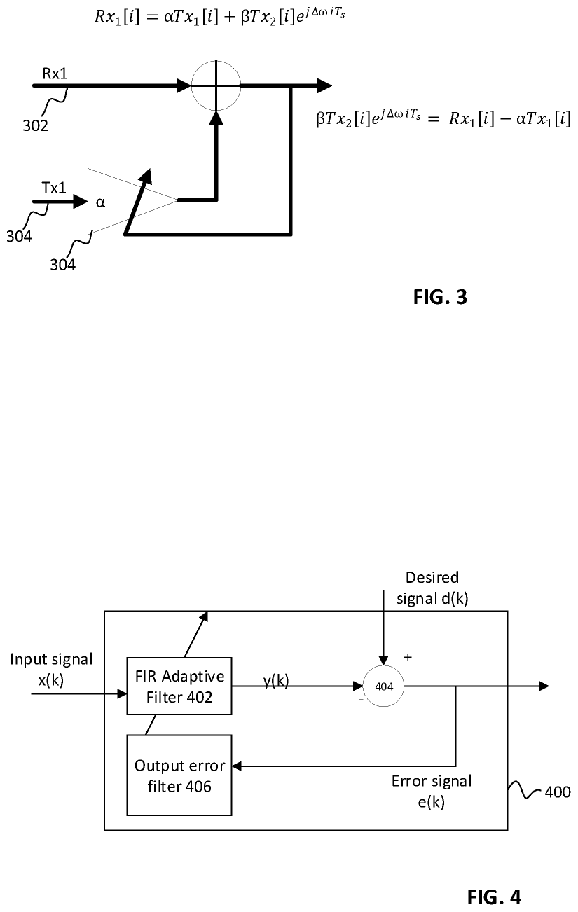

FIG. 3 depicts the isolation of βe^{j2π(i-1)ΔfT}^{ₛ} according to an aspect of the disclosure. First, as depicted in FIG. 3, and using the locally available Tx₁ samples in RH1, the device may isolate or nearly isolate the Tx2 signal by estimating α and using the estimated α term to cancel out the αTx₁ component from the received leakage signal samples (e.g. Rx₁[i]). As shown in this figure, a signal cancellation procedure can be used to determine/isolate/approximate the Tx2 signal. In this figure, the device receives Rx1 302, which is the transmission (referred to occasionally herein as the leakage signal) received at RH1. Tx1 304 is known; however, Tx1 undergoes an attenuation in the process of being transmitted, reflected off one or more objects, and received again at RH1. This attenuation is indicated by a. The device may estimate an initial value of a using any known channel-fading estimation technique. Rx1 further includes reflections of Tx2; however, assuming a frequency offset between the local oscillator of RH1 and the local oscillator of RH2, the frequency offset will cause the reflection of Tx2 to be received with a phase shift. Furthermore, as with Tx1, Tx2 will undergo an attenuation process during transmission, reflection, and reception. This attenuation process will be referred to as β. As such, Rx1 includes the attenuated, reflected Tx1 and the attenuated and phase shifted Tx2 as:

$${Rx}_{1} [ i ] = α {Tx}_{1} [ i ] + β {Tx}_{2} [ i ] {e}^{j Δω {iT}_{s}} \qquad ( 5 )$$

Of note, using the estimated α, and since Tx1 is known to the device, Tx1 will be received as approximately αTx1. As such, the attenuated and phase shifted signal of Tx2 can be isolated as:

$$β {Tx}_{2} [ i ] {e}^{j Δ ω {iT}_{s}} = {Rx}_{1} [ i ] - α {Tx}_{1} [ i ] \qquad ( 6 )$$

FIG. 4 depicts an adaptive filtering device 400 for iteratively correcting/improving the estimation of a. The adaptive filtering device 400 may be configured to receive an input signal x(k), which may be Rx1 (e.g. the received signal including reflected transmissions of Tx1 and Tx2). The FIR adaptive filter 402 may be configured to generate Tx1′, which is an approximation of Tx1 created by cancelling αTx. A classic minimum mean square error (MMSE) adaptive interference cancellation filter configuration 402, for example a Least Mean Squares filter, may be utilized for Tx₁ cancellation, where Rx₁ is used as the input signal x and Tx₁ as the desired signal d. That is, the input signal x(k) (e.g., Rx1) is adapted to undergo a cancellation of αTx, which leaves the attenuated Tx2 and noise. The output error signal will 406, then, produce the desired cancelled signal:

$$e = {Tx}_{1} - {w}^{*} {Rx}_{1} = ( 1 - {w}^{*} α ) {Tx}_{1} - {w}^{*} β {e}^{j 2 π Δ f} {Tx}_{2} + noise \qquad ( 7 )$$

The adaptive error filter 406 will converge to the minimum mean square error state of:

$$1 - {w}^{*} α = 0 or w = \frac{1}{{a}^{*}} \qquad ( 8 )$$

### Resulting in:

$$e = - \frac{β}{α} {e}^{j 2 π Δ f} {Tx}_{2} + noise \qquad ( 9 )$$

In this manner, the signal Tx2 can essentially be isolated (e.g. approximated), which serves as the basis for further calculation of the frequency offset based on a structural redundancy in the symbols, as described below.

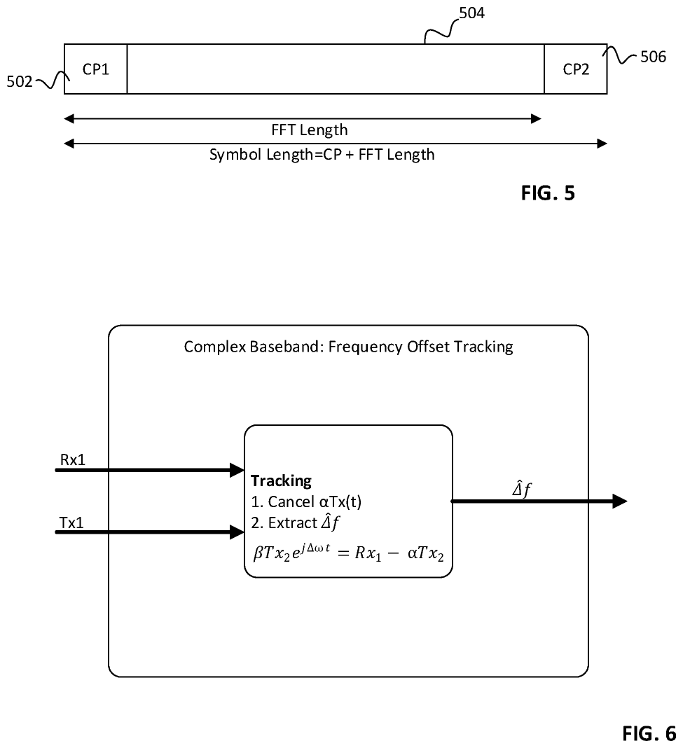

The frequency offset may be determined using the Cyclic Prefix. FIG. 5 depicts an OFDM symbol framework. The beginning segment of the OFDM symbol, called first Cyclic Prefix (CP1) 502, is appended to the end of the symbol, creating the second Cyclic Prefix (CP2) 506. That is, in a signal stream (e.g. a WLAN signal stream, a Wi-Fi signal stream, and OFDM signal stream, etc.) each OFDM symbol is appended with a Cyclic Prefix.

Because of the built-in structural redundancy of the Cyclic Prefixes, the Cyclic Prefixes can be used to estimate the frequency offset within that symbol. In the absence of a frequency offset, the two CP segments in each received symbol will be identical. However, when the local oscillators of RH1 and RH2 are at an offset Δf, the feedback receiver in RH1 will receive the Tx₂ stream with an offset frequency, which will be received as a phase shift. Therefore over the length of the symbol, i.e. FFT length, the received signal will undergo a phase shift and CP1 and CP2 will become out-of-phase with a phase difference proportional to the frequency offset such that:

$${cp}_{2} = {cp}_{1} ( {e}^{2 πΔ {fN}_{fft} {T}_{s}} ) \qquad ( 10 )$$

In light of this, the phase shift can be extracted (e.g., determined, estimated) by correlating CP1 and CP2 in each received symbol following the cancellation process described above (e.g. following the process in which αTx(t) is cancelled from Rx1). That is, and using formula 10, the first Cyclic Prefix is compared to the second Cyclic Prefix. By resolving the phase difference between the first Cyclic Prefix and the second Cyclic Prefix, Δf can be determined. That is, the frequency offset may, then, be extracted from the phase of the correlation:

$$Δ {f}_{Track} = \frac{phase ( ρ )}{2 π {T}_{fft}} \qquad ( 11 )$$

where T_{fft}=N_{fft}Tₛ and ρ=corr(cp₁, cp₂).

FIG. 6 depicts the determination of frequency offset based on the received signals Rx1 and Tx1. As depicted, a frequency offset determining circuit (e.g., configured as a standalone device, as one or more processors, as software (e.g. non-transitory computer readable medium with instructions stored thereon)) receives Rx1 (the reflected, attenuated transmissions of Tx1 and Tx2) and Tx1 (e.g., the transmission signal without reflection/attenuation loss). The frequency offset determining circuit cancels αTx(t) from Rx1, which yields βTx₂e^{jΔωt}. With the knowledge of βTx₂e^{jΔωt} the first Cyclic Prefix is compared to the second Cyclic Prefix to determine a phase shift of the second Cyclic Prefix relative to the first Cyclic Prefix, and the frequency offset is determine from the phase shift using formula (11).

The frequency offset calculations as described herein may be performed by a device or system for frequency offset calculation (the term “system” will now be used for convenience, but this is not intended to exclude a configuration as a device). The system includes a processor, which is configured to determine the frequency offset between a first local oscillator and a second local oscillator using a combined radio signal received at a first transceiver circuit, wherein the combined radio signal includes a first signal transmitted by the first transceiver circuit (Tx1 and/or αTx1) and a second signal transmitted by a second transceiver circuit (βTx2 with phase shift as described above).

The processor may be configured to determine the frequency offset between the two local oscillators by determining a plurality of sampled values of the combined radio signal; and determining the frequency offset using the plurality of sampled values. In this manner, determining the frequency offset using the plurality of sampled values may include the processor determining from the plurality of sampled values a phase of the second signal as received at the first transceiver circuit and calculating the frequency offset based on the determined phase.

Each of the initial frequency offset acquisition and payload frequency offset tracking procedures were tested using a Monte-Carlo simulation of actual WiFi6 signals, with a real leakage channel and additive white Gaussian (AWG) noise plus measured local oscillator phase noise. Performance was evaluated for the feedback receiver SNR of approximately 40-45 dB and with a leakage gain ratio α/β of around 25 dB. Acquisition results were integrated over 5 LSTF sub-segments (0.4 μs); and integration sliding windows of around 50 symbols (˜0.6 ms) were used for tracking.

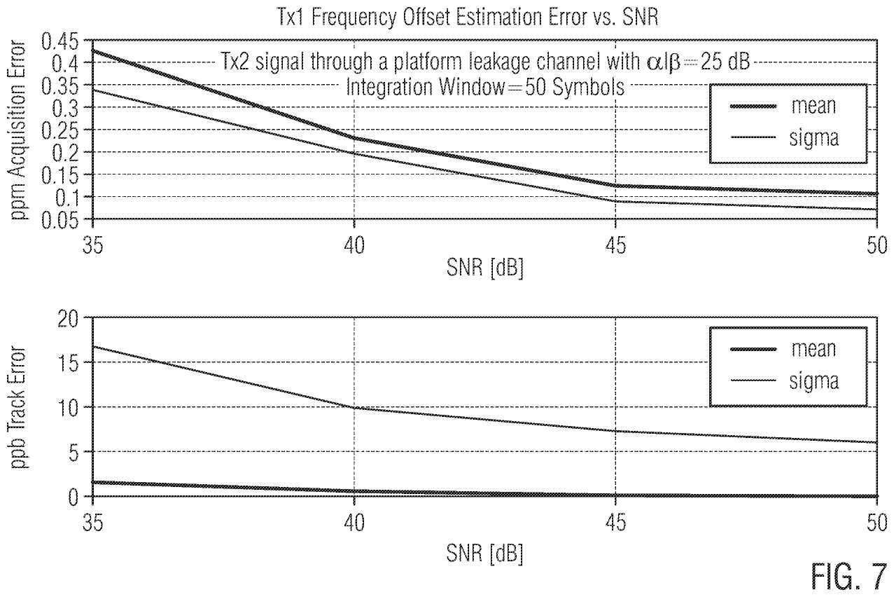

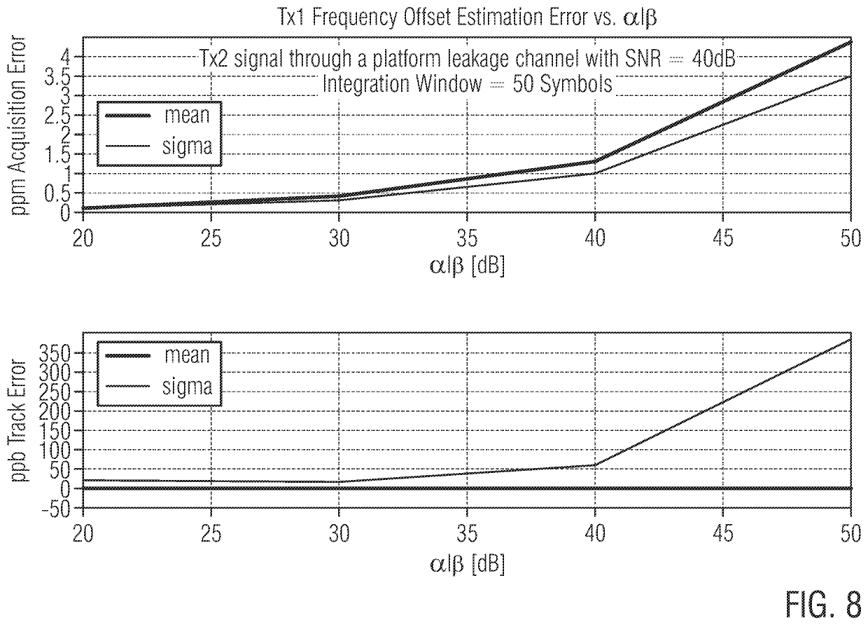

FIG. 7 and FIG. 8 depict acquisition and tracking estimation error plots. Simulation results show a very robust performance with approximately 0.2 ppm expected acquisition estimation error within 0.4 μs and tracking estimation with symbol-to-symbol expected sigma variation of about 10 ppb˜1 ppb expected mean error when offset estimation is integrated over 50 symbols. FIG. 7 and FIG. 8 demonstrate that both Acquisition and Tracking performance is remarkably insensitive to the leakage level ratio α/β and signal SNR, around the expected practical ranges of

$$20 dB < \frac{α}{β} < 35 dB$$

and 40 dB<SNR<50 dB.

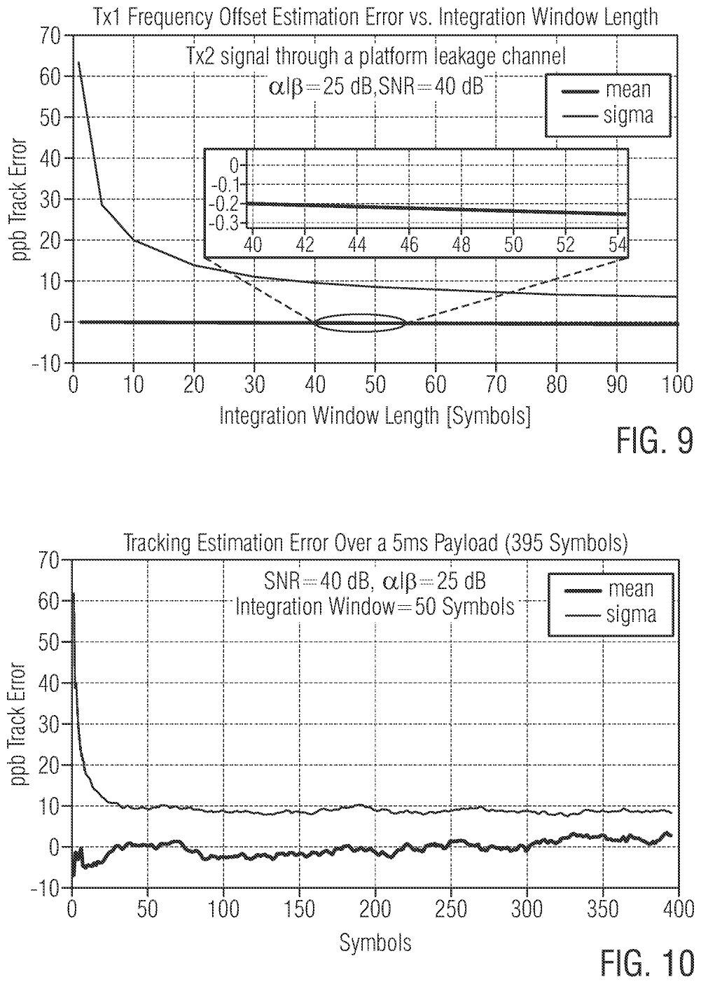

FIG. 9 depicts the expected sigma variation increasing with a smaller integration window (for tracking faster drifts) up to approximately 60 ppb with no integration. FIG. 10 depicts that the tracking error expected sigma variation begins at about 60 ppb for the initial symbols and diminishes exponentially to within 10 ppb in about 20 symbols.

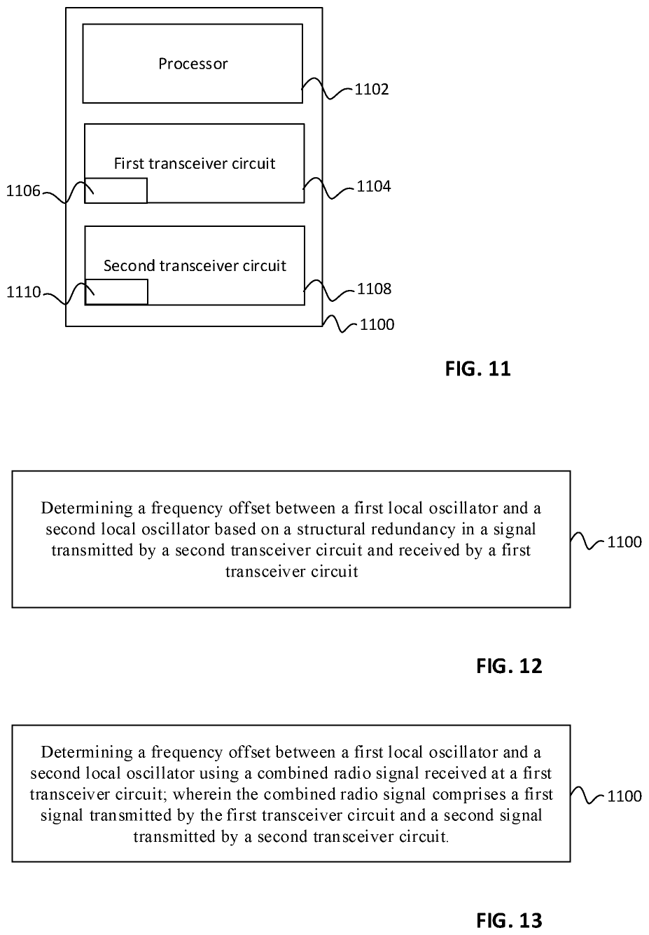

FIG. 11 depicts a system 1100 for determining a phase offset, the system including a processor 1102 configured to determine a frequency offset between a first local oscillator 1106 and a second local oscillator 1110 using a combined radio signal received at a first transceiver circuit 1104. The combined radio signal includes a first signal transmitted by the first transceiver circuit 1104 and a second signal transmitted by a second transceiver circuit 1108. The system 1100 may be configured to include the first transceiver circuit 1104, which itself may include the local oscillator 1106—The system 1100 may be further configured to include the second transceiver circuit 1108, which itself may include the second local oscillator 1110.

The system 1100 may be optionally configured such that the first transceiver circuit 1104 includes the processor 1102. In an optional configuration, the system 1100 may be configured such that the second transceiver circuit is free from a local oscillator. The system may be configured such that the processor 1102 determining the frequency offset between the first local oscillator 1106 and the second local oscillator 1110 includes the processor 1102 determining a plurality of sampled values of the combined radio signal; and determining the frequency offset using the plurality of sampled values.

The system 1100 may be optionally configured such that the processor 1102 determining the frequency offset using the plurality of sampled values includes the processor 1102 determining from the plurality of sampled values a phase of the second signal as received at the first transceiver circuit and calculating the frequency offset based on the determined phase.

The system 1100 may be optionally configured such that the processor 1102 calculating the frequency offset based on the determined phase includes the processor 1102 calculating the frequency offset based on a relationship between the determined phase and a sampling time of the plurality of sampled values. Further stating, the combined radio signal may include reflections of the first signal transmitted by the first transceiver circuit and reflections of the second signal transmitted by the second transceiver circuit and received by the first transceiver circuit. In this manner, the first signal may be transmitted concurrently with the second signal.

FIG. 12 depicts a method of frequency offset determination including determining a frequency offset between a first local oscillator and a second local oscillator based on a structural redundancy in a signal transmitted by a second transceiver circuit and received by a first transceiver circuit. The structural redundancy may be a Cyclic Prefix; wherein the signal includes a symbol beginning with the first transmission of the Cyclic Prefix, and followed by a second transmission of the Cyclic Prefix. That is, the beginning segment of the OFDM symbol, called first Cyclic Prefix (CP1), is appended to the end of the symbol, creating the second Cyclic Prefix (CP2). Alternatively or additionally, the method may include the steps of FIG. 13, including determining a frequency offset between a first local oscillator and a second local oscillator using a combined radio signal received at a first transceiver circuit; wherein the combined radio signal includes a first signal transmitted by the first transceiver circuit and a second signal transmitted by a second transceiver circuit.

Further aspects of the disclosure will now be described by way of example.

In Example 1, a system comprising a processor configured to determine a frequency offset between a first local oscillator and a second local oscillator using a combined radio signal received at a first transceiver circuit; wherein the combined radio signal comprises a first signal transmitted by the first transceiver circuit and a second signal transmitted by a second transceiver circuit.

In Example 2, the system of claim 1, further comprising: the first transceiver circuit comprising the first local oscillator; and/or the second transceiver circuit comprising the second local oscillator.

In Example 3, the system of claim 2, wherein the first transceiver circuit further comprises the processor.

In Example 4, the system of claim 2 or 3, wherein the second transceiver circuit is free from a local oscillator.

In Example 5, the system of any one of claims 1 to 4, wherein the processor determining the frequency offset between the first local oscillator and the second local oscillator comprises the processor: determining a plurality of sampled values of the combined radio signal; and determining the frequency offset using the plurality of sampled values.

In Example 6, the system of claim 5, wherein the processor determining the frequency offset using the plurality of sampled values comprises the processor determining from the plurality of sampled values a phase of the second signal as received at the first transceiver circuit and calculating the frequency offset based on the determined phase.

In Example 7, the system of claim 6, wherein the processor calculating the frequency offset based on the determined phase comprises the processor calculating the frequency offset based on a relationship between the determined phase and a sampling time of the plurality of sampled values.

In Example 8, the system of claim 1 or 7, wherein the combined radio signal comprises reflections of the first signal transmitted by the first transceiver circuit and reflections of the second signal transmitted by the second transceiver circuit and received by the first transceiver circuit.

In Example 9, the system of claim 1 or 8, wherein the first signal is transmitted concurrently with the second signal.

In Example 10, the system comprising: a processor configured to determine a frequency offset between a first local oscillator and a second local oscillator based on a structural redundancy in a signal transmitted by a second transceiver circuit and received by a first transceiver circuit.

In Example 11, the system of claim 10, further comprising: the first transceiver circuit comprising the first local oscillator; and/or the second transceiver circuit comprising the second local oscillator.

In Example 12, the system of claim 11, wherein the first transceiver circuit further comprises the processor.

In Example 13, the system of claim 11, wherein the second transceiver circuit is free from a local oscillator.

In Example 14, the system of any one of claims 10 to 13, wherein the structural redundancy is a Cyclic Prefix; and wherein the signal comprises a symbol beginning with the first transmission of the Cyclic Prefix, followed by a second transmission of the Cyclic Prefix.

In Example 15, the system of claim 14, wherein the processor determining the frequency offset between the first local oscillator and the second local oscillator using the structural redundancy comprises the processor determining a phase difference between the Cyclic Prefix transmitted after the symbol and the Cyclic prefix transmitted at the beginning of the symbol, and determining the frequency offset based on the detected phase difference.

In Example 16, the system of any one of claims 10 to 15, wherein the processor is configured to receive a radio signal representing a transmission of the first transceiver circuit and a transmission of the second transceiver circuit; wherein the processor is configured to determine the frequency offset between the first local oscillator and the second local oscillator using the received radio signal.

In Example 17, the system of claim 16, wherein the first transceiver circuit further comprises a filter, configured to receive the radio signal, filter from the radio signal an estimation of the transmission of the first transceiver circuit, and output an output signal representing the radio signal from which the estimation of the transmission of the first transceiver circuit has been filtered.

In Example 18, the system of claim 17, wherein the output signal corresponds to the transmission of the second transceiver circuit.

In Example 19, the system of claim 17, wherein the processor is configured to determine a difference between the output signal and a reference signal; and wherein the processor is configured to determine a next estimation of the transmission of the first transceiver circuit based on the difference.

In Example 20, the system of any one of claims 17 to 19, wherein the filter is a finite impulse response filter.

In Example 21, a non-transitory computer readable medium, comprising instructions which, if executed by one or more processors, are configured to cause the one or more processors to: determine a frequency offset between a first local oscillator and a second local oscillator using a combined radio signal received at a first transceiver circuit; wherein the combined radio signal comprises a first signal transmitted by the first transceiver circuit and a second signal transmitted by a second transceiver circuit.

In Example 22, the non-transitory computer readable medium of claim 21, wherein the instructions being configured to cause the processor to determine the frequency offset between the first local oscillator and the second local oscillator comprises the instructions being configured to cause the processor to determine a plurality of sampled values of the combined radio signal; and determine the frequency offset using the plurality of sampled values.

In Example 23, the non-transitory computer readable medium of claim 22, wherein the instructions being configured to cause the processor to determine the frequency offset using the plurality of sampled values comprises the instructions being configured to cause the processor to determine from the plurality of sampled values a phase of the second signal as received at the first transceiver circuit and calculating the frequency offset based on the determined phase.

In Example 24, the non-transitory computer readable medium of claim 23, wherein the instructions being configured to cause the processor to calculate the frequency offset based on the determined phase comprises the instructions being configured to cause the processor to calculate the frequency offset based on a relationship between the determined phase and a sampling time of the plurality of sampled values.

In Example 25, the non-transitory computer readable medium of claim 21 or 24, wherein the combined radio signal comprises reflections of the first signal transmitted by the first transceiver circuit and reflections of the second signal transmitted by the second transceiver circuit and received by the first transceiver circuit.

In Example 26, the non-transitory computer readable medium of claim 21 or 25, wherein the first signal is transmitted concurrently with the second signal.

In Example 27, a non-transitory computer readable medium, comprising instructions which, if executed by one or more processors, are configured to cause the one or more processors to: determine a frequency offset between a first local oscillator and a second local oscillator based on a structural redundancy in a signal transmitted by a second transceiver circuit and received by a first transceiver circuit.

In Example 28, the non-transitory computer readable medium of claim 27, wherein the structural redundancy is a Cyclic Prefix; and wherein the signal comprises a symbol beginning with the first transmission of the Cyclic Prefix, followed by a second transmission of the Cyclic Prefix.

In Example 29, the non-transitory computer readable medium of claim 28, wherein the processor determining the frequency offset between the first local oscillator and the second local oscillator using the structural redundancy comprises the processor determining a phase difference between the Cyclic Prefix transmitted after the symbol and the Cyclic Prefix transmitted at the beginning of the symbol, and determining the frequency offset based on the detected phase difference.

In Example 30, the non-transitory computer readable medium of any one of claims 27 to 29, wherein the instructions are further configured to cause the processor to receive a radio signal representing a transmission of the first transceiver circuit and a transmission of the second transceiver circuit; wherein the processor is configured to determine the frequency offset between the first local oscillator and the second local oscillator using the received radio signal.

In Example 31, the non-transitory computer readable medium of claim 30, wherein the output signal corresponds to the transmission of the second transceiver circuit.

In Example 32, the non-transitory computer readable medium of claim 30, wherein the instructions are further configured to cause the processor to determine a difference between the output signal and a reference signal; and wherein the instructions are further configured to cause the processor to determine a next estimation of the transmission of the first transceiver circuit based on the difference.

In Example 33, a system comprising: a processing means for determining a frequency offset between a first local oscillator and a second local oscillator using a combined radio signal received at a first transceiver circuit; wherein the combined radio signal comprises a first signal transmitted by the first transceiver circuit and a second signal transmitted by a second transceiver circuit.

In Example 34, the system of claim 33, further comprising: the first transceiving means comprising the first local oscillating means; and/or the second transceiving means comprising the second local oscillator.

In Example 35, the system of claim 34, wherein the first transceiving means further comprises the processing means.

In Example 36, the system of claim 34 or 35, wherein the second transceiving means is free from a local oscillator.

In Example 37, the system of any one of claims 33 to 36, wherein the processing means being for determining the frequency offset between the first local oscillator and the second local oscillator comprises the processing means being for determining a plurality of sampled values of the combined radio signal; and determining the frequency offset using the plurality of sampled values.

In Example 38, the system of claim 37, wherein the processing means being for determining the frequency offset using the plurality of sampled values comprises the processing means being for determining from the plurality of sampled values a phase of the second signal as received at the first transceiver circuit and calculating the frequency offset based on the determined phase.

In Example 39, the system of claim 38, wherein the processing means being for calculating the frequency offset based on the determined phase comprises the processing means being for calculating the frequency offset based on a relationship between the determined phase and a sampling time of the plurality of sampled values.

In Example 40, the system of claim 33 or 39, wherein the combined radio signal comprises reflections of the first signal transmitted by the first transceiving means and reflections of the second signal transmitted by the second transceiving means and received by the first transceiving means.

In Example 41, the system of claim 33 or 40, wherein the first signal is transmitted concurrently with the second signal.

In Example 42, a system comprising: a processing means configured to determine a frequency offset between a first local oscillator and a second local oscillator based on a structural redundancy in a signal transmitted by a second transceiver circuit and received by a first transceiver circuit.

In Example 43, the system of claim 42, further comprising: the first transceiving means circuit comprising the first local oscillator; and/or the second transceiving means comprising the second local oscillator.

In Example 44, the system of claim 43, wherein the first transceiving means further comprises the processing means.

In Example 45, the system of claim 43, wherein the second transceiving means is free from a local oscillator.

In Example 46, the system of any one of claims 42 to 45, wherein the structural redundancy is a Cyclic Prefix; and wherein the signal comprises a symbol beginning with the first transmission of the Cyclic Prefix, followed by a second transmission of the Cyclic Prefix.

In Example 47, the system of claim 46, wherein the processing means determining the frequency offset between the first local oscillator and the second local oscillator using the structural redundancy comprises the processing means determining a phase difference between the Cyclic Prefix transmitted after the symbol and the Cyclic Prefix transmitted at the beginning of the symbol, and determining the frequency offset based on the detected phase difference.

In Example 48, the system of any one of claims 42 to 47, wherein the processing means is configured to receive a radio signal representing a transmission of the first transceiving means and a transmission of the second transceiving means; wherein the processing means is configured to determine the frequency offset between the first local oscillator and the second local oscillator using the received radio signal.

In Example 49, the system of claim 48, wherein the first transceiving means further comprises a filter, configured to receive the radio signal, filter from the radio signal an estimation of the transmission of the first transceiving means, and output an output signal representing the radio signal from which the estimation of the transmission of the first transceiving means has been filtered.

In Example 50, the system of claim 49, wherein the output signal corresponds to the transmission of the second transceiving means.

In Example 51, the system of claim 49, wherein the processing means is configured to determine a difference between the output signal and a reference signal; and wherein the processing means is configured to determine a next estimation of the transmission of the first transceiving means based on the difference.

In Example 52, the system of any one of claims 49 to 51, wherein the filter is a finite impulse response filter.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A system comprising:
a processor configured to determine a frequency offset between a first local oscillator and a second local oscillator using a combined radio signal received at a first transceiver circuit;
wherein the combined radio signal comprises a first signal transmitted by the first transceiver circuit and a second signal transmitted by a second transceiver circuit.

2. The system of claim 1, further comprising:
the first transceiver circuit comprising the first local oscillator; and/or
the second transceiver circuit comprising the second local oscillator.

3. The system of claim 1, wherein the processor determining the frequency offset between the first local oscillator and the second local oscillator comprises the processor:
determining a plurality of sampled values of the combined radio signal; and
determining the frequency offset using the plurality of sampled values.

4. The system of claim 3, wherein the processor determining the frequency offset using the plurality of sampled values comprises the processor determining from the plurality of sampled values a phase of the second signal as received at the first transceiver circuit and calculating the frequency offset based on the determined phase.

5. The system of claim 4, wherein the processor calculating the frequency offset based on the determined phase comprises the processor calculating the frequency offset based on a relationship between the determined phase and a sampling time of the plurality of sampled values.

6. The system of claim 1, wherein the combined radio signal comprises reflection of the first signal transmitted by the first transceiver circuit and reflections of the second signal transmitted by the second transceiver circuit and received by the first transceiver circuit.

7. The system of claim 1, wherein the first signal is transmitted concurrently with the second signal.

8. A system comprising:
a processor configured to determine a frequency offset between a first local oscillator and a second local oscillator based on a structural redundancy in a signal transmitted by a second transceiver circuit and received by a first transceiver circuit.

9. The system of claim 8, further comprising:
the first transceiver circuit comprising the first local oscillator; and/or
the second transceiver circuit comprising the second local oscillator.

10. The system of claim 9, wherein the structural redundancy is a Cyclic Prefix; and
wherein the signal comprises a symbol beginning with the first transmission of the Cyclic Prefix, followed by a second transmission of the Cyclic Prefix.

11. The system of claim 10, wherein the processor determining the frequency offset between the first local oscillator and the second local oscillator using the structural redundancy comprises the processor determining a phase difference between the Cyclic Prefix transmitted after the symbol and the Cyclic prefix transmitted at the beginning of the symbol, and determining the frequency offset based on the detected phase difference.

12. The system of claim 8, wherein the processor is configured to receive a radio signal representing a transmission of the first transceiver circuit and a transmission of the second transceiver circuit; wherein the processor is configured to determine the frequency offset between the first local oscillator and the second local oscillator using the received radio signal.

13. The system of claim 12, wherein the first transceiver circuit further comprises a filter, configured to receive the radio signal, filter from the radio signal an estimation of the transmission of the first transceiver circuit, and output an output signal representing the radio signal from which the estimation of the transmission of the first transceiver circuit has been filtered.

14. The system of claim 13, wherein the output signal corresponds to the transmission of the second transceiver circuit.

15. The system of claim 13, wherein the processor is configured to determine a difference between the output signal and a reference signal; and wherein the processor is configured to determine a next estimation of the transmission of the first transceiver circuit based on the difference.

16. The system of claim 13, wherein the filter is a finite impulse response filter.

17. A non-transitory computer readable medium, comprising instructions which, if executed by one or more processors, are configured to cause the one or more processors to:
determine a frequency offset between a first local oscillator and a second local oscillator using a combined radio signal received at a first transceiver circuit;
wherein the combined radio signal comprises a first signal transmitted by the first transceiver circuit and a second signal transmitted by a second transceiver circuit.

18. The non-transitory computer readable medium of claim 17, wherein the instructions being configured to cause the processor to determine the frequency offset between the first local oscillator and the second local oscillator comprises the instructions being configured to cause the processor to determine a plurality of sampled values of the combined radio signal; and determine the frequency offset using the plurality of sampled values.

19. A non-transitory computer readable medium, comprising instructions which, if executed by one or more processors, are configured to cause the one or more processors to:
determine a frequency offset between a first local oscillator and a second local oscillator based on a structural redundancy in a signal transmitted by a second transceiver circuit and received by a first transceiver circuit.

20. The non-transitory computer readable medium of claim 19, wherein the structural redundancy is a Cyclic prefix; and wherein the signal comprises a symbol beginning with the first transmission of the Cyclic Prefix, followed by a second transmission of the Cyclic Prefix.
